(19) United States
(12) Patent Application Publication
(10) Pub. No.: US 2015/0330349 A1
(43) Pub. Date: Nov. 19, 2015

(54) METHOD AND APPARATUS FOR DETECTING LEAKAGE OF FUEL EVAPORATIVE GAS

(71) Applicant: Hyundai Autron Co., Ltd., Seongnam-si (KR)

(72) Inventor: Dong Ha KIM, Anyang-si (KR)

(73) Assignee: Hyundai Autron Co., Ltd., Seongnam-si (KR)

(21) Appl. No.: 14/714,044

(22) Filed: May 15, 2015

(30) Foreign Application Priority Data
May 16, 2014 (KR) 10-2014-0059212

(51) Int. Cl. F02M 65/00; F02M 25/08

(52) U.S. Cl. CPC F02M 65/006; F02M 25/089

(57) ABSTRACT

Disclosed is an apparatus and method for detecting a leakage of fuel evaporative gas in a vehicle fuel system. When preset condition information is satisfied during operation of a vehicle, the apparatus and method may control a canister purge valve, and generate detection information on a leakage of fuel evaporative gas based on switch state information of a pressure switch provided in a natural vacuum leakage detection (NVLD) module, thereby detecting a leakage of the fuel evaporative gas during operation.

### CROSS-REFERENCES TO RELATED APPLICATIONS

The present application claims priority to Korean application number 10-2014-0059212, filed on May 16, 2014, which is incorporated by reference in its entirety.

### BACKGROUND OF THE INVENTION

The present invention relates to a method and apparatus for detecting a leakage of fuel evaporative gas.

The contents described in this section only provide background information on embodiments of the present invention, but do not form a related art.

With the increase in use and number of vehicles, the performances of the vehicles have been focused on environmental problems as well as stability. Among various factors which cause the environmental problems, pollution caused by vehicles occupies a large proportion of the environmental problems. Recently, as the number of vehicles increases, the regulations of OBD-II (On-Board Diagnostics-II) have been enforced to regulate pollution caused by the vehicles.

Exhaust gas from vehicles may include combustion gas which is discharged through a muffler, incomplete combustion gas which is discharged from a crank case and a fuel system from a fuel tank to an engine, and fuel evaporative gas which is generated when fuel stored in the fuel tank of the vehicle evaporates with the increase of ambient temperature.

The fuel evaporative gas in the fuel tank is composed of hydrocarbon. Thus, when the fuel evaporative gas is discharged to the air, the fuel evaporative gas serves as a material causing air pollution, for example, ozone depletion. Therefore, the vehicle collects and stores the fuel evaporative gas generated through the evaporation of fuel into a canister. Then, when the temperature of cooling water and the engine RPM reach predetermined levels after the engine is started, the fuel evaporative gas stored in the canister is introduced into the engine and then burned. The fuel evaporative gas in the vehicle fuel system may leak due to various reasons such as valve breakdown, pipe damage, and sensor/switch breakdown. Recently, various researches have been conducted on a method for detecting a leakage of fuel evaporative gas.

The leakage detection system may include a vacuum method, a pressurization method, a permeation method and the like. Among the various leakage detection systems, a system using NVLD (Natural Vacuum Leakage Detection) may detect changes in pressure within a fuel tank based on changes of the ambient temperature, while the vehicle is stopped for several hours, and relatively simply detect a leak of about 0.5 mm. However, the leakage detection system using NVLD cannot detect a leak during vehicle operation. In other words, the conventional leakage detection system using NVLD must satisfy environmental conditions such as an engine stop time (for example, four hours) and an ambient temperature change (for example, 6□), in order to detect a leakage using only the information of the NVLD module. Thus, the leakage detection system cannot detect a leakage of fuel evaporative gas while the vehicle is operated. Furthermore, since the leakage detection system using NVLD detects a leakage using only the information of the NVLD module, the leakage detection system detects a leakage of 0.5 mm or more in the same manner as the leakage of 0.5 mm.

### SUMMARY OF THE INVENTION

Embodiments of the present invention are directed to an apparatus and method for detecting a leakage of fuel evaporative gas, which controls a canister purge valve (CPV) when preset condition information is satisfied during operation of a vehicle, and generates detection information on a leakage of fuel evaporative gas based on switch state information of a pressure switch provided in an NVLD module, thereby detecting a leakage of fuel evaporative gas during operation.

In one embodiment, an apparatus for detecting a leak of fuel evaporative gas may include: a switch check unit configured to check switch state information on the open state or close state of a pressure switch included in an NVLD module; a condition determination unit configured to determine whether to activate leakage detection for fuel evaporative gas, based on preset detection activation condition information; a purge control unit configured to control a valve switching operation of a CPV; and a detection control unit configured to control internal pressure of a fuel tank to be maintained at the preset reference negative pressure or less according to control of the CPV, when the leakage detection is activated according to the switch state information, recheck the switch state information which is changed according to a variation of the internal pressure, and generate detection information by determining whether the fuel evaporative gas is leaking.

In another embodiment, a method for detecting a leakage of fuel evaporative gas may include a switch operation step of checking the state of a pressure switch included in an NVLD module when an engine is started; a determination step of determining whether to activate leakage detection based on preset detection activation condition information, when the pressure switch is opened; a switch recheck step of controlling an operation of a CPV when the leakage detection is activated, and rechecking the state of the pressure switch based on the operation of the CPV; and a leakage detection step of generating detection information by detecting whether the fuel evaporative gas is leaking, based on the state of the pressure switch at the switch recheck step.

### BRIEF DESCRIPTION OF THE DRAWINGS

FIG. 1 is a block configuration diagram schematically illustrating a vehicle fuel system in accordance with an embodiment of the present invention.

FIG. 2 is a block configuration diagram schematically illustrating an electronic control unit in accordance with the embodiment of the present invention.

FIG. 3 is a flowchart for describing a method for detecting a leakage of fuel evaporative gas in accordance with an embodiment of the present invention.

FIG. 4 is a graph for describing an operation of detecting a leakage of fuel evaporative gas in the electronic control unit in accordance with the embodiment of the present invention.

### DESCRIPTION OF SPECIFIC EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

The principle of detecting a leakage of fuel evaporative gas in a vehicle fuel system in accordance with an embodiment of the present invention may be summarized as follows.

The vehicle fuel system may detect a leakage of fuel evaporative gas based on an operation state indicating whether a pressure switch included in an NVLD module is opened or closed. The switch may be closed when the internal pressure of a fuel tank is equal to or less than a preset reference negative pressure, and opened when the internal pressure of the fuel tank is more than the reference negative pressure.

When a negative pressure is formed in the fuel tank such that the pressure switch is changed to the open state at the time at which the pressure switch needs to be maintained in the close state, the vehicle fuel system may determine that fuel evaporative gas is leaking. The reason may be described as follows. When the fuel evaporative gas is leaking, the internal pressure of the fuel tank may be rapidly recovered toward the ambient pressure, and excessively rise over a preset reference negative pressure at the time at which the state of the pressure switch is measured, thereby opening the pressure switch.

Based on the above-described principle, the embodiments of the present invention will be described in detail with reference to the accompanying drawings.

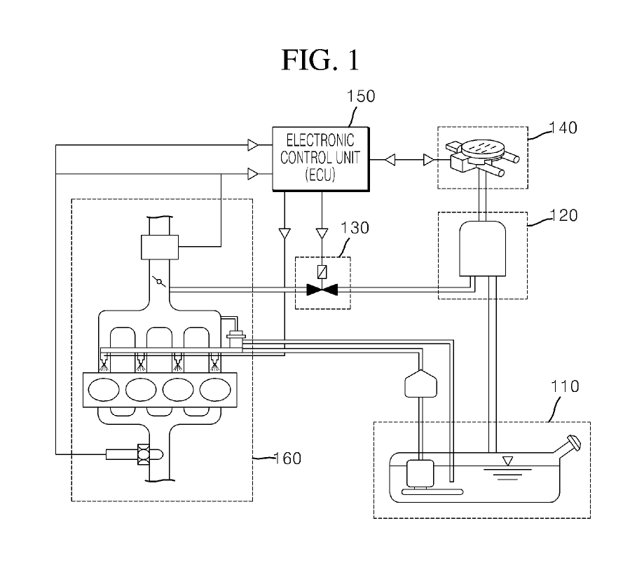

FIG. 1 is a block configuration diagram schematically illustrating a vehicle fuel system in accordance with an embodiment of the present invention.

The vehicle fuel system in accordance with the embodiment of the present invention may include a fuel tank 110, a canister 120, a canister purge valve (CPV) 130, a natural vacuum leakage detection (NVLD) module 140, an electronic control unit 150, and an engine 160.

The fuel tank 110 may store fuel which is supplied to an internal combustion engine in order to operate a vehicle. Inside the fuel tank 110, fuel evaporative gas (hydrocarbon, HC) may be generated as the fuel evaporates due to the temperature increase. The fuel tank 110 may be connected to the canister 120 for collecting the fuel evaporative gas, and discharge the fuel evaporative gas to the canister 120. Furthermore, the fuel tank 110 may be connected to the engine 160 in order to supply fuel. The engine 160 may convert thermal energy into mechanical energy by burning fuel, thereby generating power for the vehicle. The engine 160 may include a combustion chamber for burning the fuel supplied from the fuel tank 110, and the combustion chamber may burn the fuel evaporative gas introduced from the canister 120.

The canister 120 may include charcoal having strong adsorptive power, and adsorb and store fuel evaporative gas generated from the fuel tank 110. More specifically, the canister 120 may collect the evaporative gas generated from the fuel tank 100, and prevent the evaporative gas from being discharged to the air. When the engine 160 is started, the canister 120 may introduce fuel evaporative gas stored therein into the combustion chamber through an intake manifold such that the fuel evaporative gas is burned with fuel. The canister 120 may be connected to the fuel tank 110 through a pipe, connected to the CPV 130 for controlling the introduction of fuel evaporative gas, and connected to the NVLD module 140 for measuring a change in ambient temperature and pressure of the fuel tank 110.

The canister 120 may introduce fuel evaporative gas into the combustion chamber of the engine 160 according to a switching operation of the CPV 130 which is controlled according to a command of the electronic control unit 150.

The CPV 130 may be positioned at the pipe for connecting the combustion chamber of the engine 160 to the canister 120, and control the discharge of fuel evaporative gas adsorbed on the canister 120 based on a control command of the electronic control unit 150.

The CPV 130 may switch a purge valve to an open state when an open control command is received from the electronic control unit 150, and switch the purge valve to a close state when a close control command is received from the electronic control unit 150.

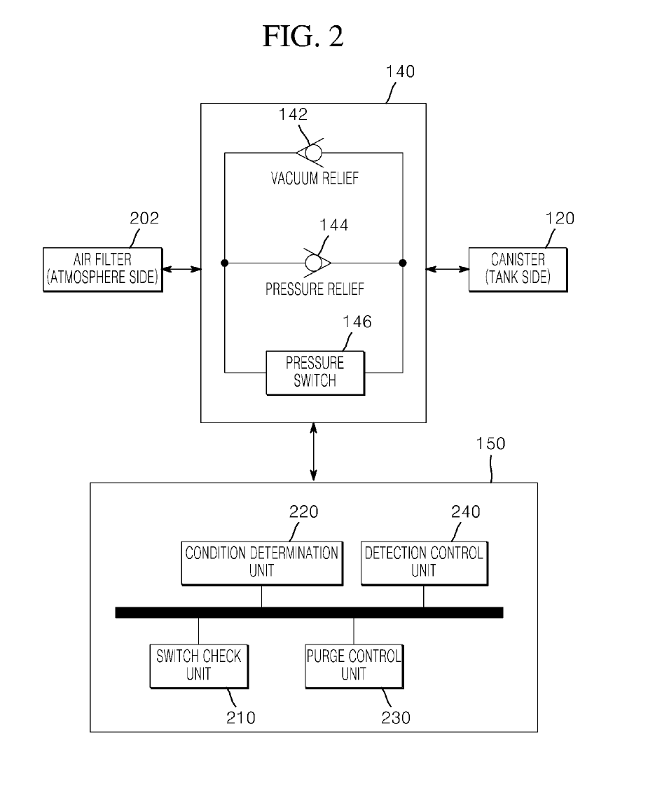

The NVLD module 140 may be positioned between the canister 120 and an air filter 202 (at the atmosphere side), and measure a change in ambient temperature and pressure of the fuel tank 110. The NVLD module 140 in accordance with the embodiment of the present invention may include a vacuum relief 142, a pressure relief 144, and a pressure switch 146. The vacuum relief 142 may prevent excessive vacuum from being formed in the fuel tank 110, the pressure relief 144 may prevent excessive pressure from occurring in the fuel tank 110, and the pressure switch 146 may be switched to the open or close state according to the negative pressure within the fuel tank 110. The components of the NVLD module 140 are illustrated in FIG. 2.

The pressure switch 146 included in the NVLD module 140 may be operated in the close state when the internal pressure of the fuel tank 110 is equal to or less than the preset reference negative pressure, and operated in the open state when the internal pressure of the fuel tank 110 is more than the reference negative pressure.

The electronic control unit 150 may control overall operations of the vehicle and detect a leakage of fuel evaporative gas. The electronic control unit 150 may not only electronically control the fuel supply system, but also control functions related to exhaust gas recirculation (EGR), ignition time, and idling revolutions, using a microcomputer. Furthermore, the electronic control unit 150 may include a self-detection program for monitoring an error which can occur in the vehicle. For example, the self-detection program may perform fuel injection control, ignition time control, idling speed control, EGR control, fuel pump control, exhaust temperature alarm control, and self detection function.

The electronic control unit 150 in accordance with the embodiment of the present invention may control the CPV 130 and the NVLD module 140 based on parameters related to fuel control, such as the amount of fuel evaporative gas collected in the canister 120, the internal pressure of the fuel tank 110, and the vehicle state.

The electronic control unit 150 may check the state of the pressure switch 146 included in the NVLD module 140 immediately after the engine 160 is started. When the pressure switch 146 is opened, the electronic control unit 150 may check whether vehicle state information satisfies preset detection activation condition information. The vehicle state information may indicate overall information on the vehicle in operation, such as the temperature state, engine state, fuel state, and speed state of the vehicle. The detection activation condition information may indicate information on reference conditions which are set by a manager or a system designer in order to activate leakage detection for fuel evaporative gas during operation. For example, the detection activation condition information may include a related component state condition, an ambient temperature condition, an engine stop time condition, an engine operation time condition, a fuel level condition, a constant vehicle speed operation condition, and a purge flow rate condition.

When the vehicle state information of the vehicle in operation satisfies all the pieces of the detection activation condition information, the electronic control unit 150 may activate leakage detection, and switch the CPV 130 to the open state. When the operation is continued in a state where the CPV 130 is opened, negative pressure within the fuel tank 110 may be generated due to the negative pressure formed in the combustion chamber of the engine 160, and the internal pressure of the fuel tank 110 may gradually fall. When the negative pressure reaches the preset reference negative pressure in the fuel tank 110, the pressure switch 146 included in the NVLD module 140 may be switched to the close state.

Even after the pressure switch 146 is switched to the close state, the negative pressure of the fuel tank 110 may gradually fall. When the negative pressure reaches the NVLD relief pressure which corresponds to the minimum pressure and is maintained by the vacuum relief 142, the negative pressure may be maintained. When the negative pressure is maintained for a predetermined time, the electronic control unit 150 may switch the CPV 130 to the close state, and perform a leakage detection operation.

Specifically, the electronic control unit 150 may measure a valve close time during which the CPV 130 is closed, and check the state of the pressure switch 146 included in the NVLD module 140 when the valve close time reaches a preset critical value. The preset critical value may be determined on the basis of a fuel level and ambient temperature, and varied according to the change of the fuel level and the ambient temperature.

When checking that the pressure switch 146 included in the NVLD module 140 is opened, the electronic control unit 150 may determine that fuel evaporative gas is leaking from the vehicle fuel system, and generate detection information on the leakage of fuel evaporative gas. The reason may be described as follows. When the fuel evaporative gas is leaking, the internal pressure of the fuel tank 110 may be rapidly recovered toward the ambient pressure, and excessively rise over the preset reference negative pressure at the time at which the state of the pressure switch 146 is measured. Thus, the electronic control unit 150 may determine that the pressure switch 146 is opened. The electronic control unit 150 may control an engine check warning light MIL to be turned on according to the detection information on the leakage, thereby warning a driver of the vehicle abnormality.

When checking that the pressure switch 146 included in the NVLD module 140 is closed, the electronic control unit 150 may determine that fuel evaporative gas is not leaking from the vehicle fuel system, and generate detection information on no leakage. That is because the internal pressure of the fuel tank 110 does not excessively rise over the preset reference negative pressure, but is maintained at the reference negative pressure or less.

In the embodiment of the present invention, it has been described that the electronic control unit 150 is provided in the vehicle fuel system and detects a leakage of fuel evaporative gas. However, the present invention is not limited thereto, but a leakage detection device may be provided separately from the electronic control unit for controlling overall operations of the vehicle, and detect a leakage of fuel evaporative gas.

FIG. 2 is a block configuration diagram schematically illustrating the electronic control unit in accordance with the embodiment of the present invention.

The electronic control unit 150 in accordance with the embodiment of the present invention may include a switch check unit 210, a condition determination unit 220, a purge control unit 230, and a detection control unit 240. The components of the electronic control unit 150 in accordance with the embodiment of the present invention may be connected to each other through a bus Bus. The bus serving as a communication path for connecting the electronic control unit, nodes, and modules within the system may include a bus system such as CAN (Controller Area Network), RS485 bus, VME (Versa Module Eurocard) bus, or multi-bus, a next-generation bus system, and various wired/wireless network structures.

The switch check unit 210 may check the state of the pressure switch 146 included in the NVLD module 140. The switch check unit 210 may check the switch state information on the open or close state of the pressure switch 146, and transmit the switch state information to the detection control unit 240. The detection control unit 240 may generate detection information on a leakage of fuel evaporative gas.

When a request signal for switch check is received from the detection control unit 240, the switch check unit 210 may check the state of the pressure switch 146. However, the present invention is not limited thereto, but the switch check unit 210 may automatically check the state of the pressure switch 146 at each preset cycle, and transmit the checked switch state information to the detection control unit 240.

The condition determination unit 220 may determine whether to activate leakage detection, based on the preset detection activation condition information.

The condition determination unit 220 may acquire vehicle state information during operation of the vehicle, and activate leakage detection for fuel evaporative gas, when the vehicle state information satisfies all the pieces of the detection activation condition information. When the acquired vehicle state information does not satisfy one or more pieces of the detection activation condition information, the condition determination unit 220 may deactivate leakage detection for fuel evaporative gas. The vehicle state information may indicate overall information on the vehicle in operation, such as the temperature state, engine state, fuel state, and speed state of the vehicle. The detection activation condition information may indicate information on reference conditions which are preset by a manager in order to activate leakage detection for fuel evaporative gas during operation. For example, the detection activation condition information may include a related component state condition, an ambient temperature condition, an engine stop time condition, an engine operation time condition, a fuel level condition, a constant vehicle speed operation condition, and a purge flow rate condition.

For example, the condition determination unit 220 may acquire vehicle state information during operation of the vehicle, and activate the leakage detection for fuel evaporative gas, when the vehicle state information satisfies all the pieces of the detection activation condition information, that is, ‘no related-component error’, ‘ambient temperature>−10° C.’, ‘engine stop time>four hours’, ‘engine operation time<20 minutes’, ‘7 L<fuel level<40 L’, ‘|filtered vehicle speed− current vehicle speed|>=2 km/h’, and ‘purge flow rate>3 kg/h’.

However, the condition determination unit 220 may check the vehicle state information at each preset cycle after the leakage detection is activated, and deactivate the leakage detection when the vehicle state information corresponds to a preset detection cancellation condition. The detection cancellation condition may indicate a preset condition at which it is determined that leakage detection for fuel evaporative gas during operation cannot be normally performed. For example, the condition determination unit 220 may deactivate the leakage detection, when one or more of the constant vehicle speed operation condition, the fuel level condition, the ambient pressure condition, and the purge flow rate condition are not satisfied, or when it is checked that an error occurred in related parts or the vehicle entered an unpaved road.

For example, the condition determination unit 220 may acquire the vehicle state information during vehicle operation, and deactivate the leakage detection when the vehicle state information corresponds to any one of detection cancellation conditions such as ‘|filtered vehicle speed−current vehicle speed|>2 km/h’, ‘|filtered fuel level−current fuel level|>=5 L’, ‘occurrence of related-component error’, ‘ ambient pressure<=750 hPa’, ‘wheel acceleration>=30 m/s²’, and ‘purge flow rate<=3 kg/h’.

The purge control unit 230 may control a valve switching operation of the CPV 130.

When the leakage detection is activated, the purge control unit 230 in accordance with the embodiment of the present invention may transmit an open control command to the CPV 130, and switch the CPV 130 to the open state. While the CPV 130 is opened, negative pressure formed in the intake manifold connected to the combustion chamber may be transmitted to the fuel tank 110 during operation of the vehicle. Then, negative pressure may start to be formed in the fuel tank 110.

When a purge integrated value, a purge flow rate, a satisfaction time condition and the like are satisfied, that is, when the vehicle is normally operated, the CPV 130 may continuously maintain the open state, and the negative pressure within the fuel tank 110 may gradually decrease with the activity of the combustion chamber during the operation of the vehicle.

When the negative pressure within the fuel tank 110 reaches the preset reference negative pressure such that the pressure switch 146 of the NVLD module 140 is switched from the open state to the close state, the purge control unit 230 may transmit a close control command to the CPV 130, and switch the CPV 130 to the close state. The purge control unit 230 may control the CPV 130 to maintain the close state for a predetermined time. Then, the detection control unit 240 may determine the state of the pressure switch 146 of the NVLD module 140, and detect a leakage of fuel evaporative gas.

The detection control unit 240 in accordance with the embodiment of the present invention may receive the switch state information on the pressure switch 146 included in the NVLD module 140 from the switch check unit 210, and generate detection information by detecting leakage of fuel evaporative gas based on the switch state information, through multiple steps.

First, the detection control unit 240 may check the switch state information received from the switch check unit 210 immediately after the engine 160 is started.

Then, the detection control unit 240 may additionally check the switch state information while the condition determination unit 220 activates the leakage detection, the purge control unit 230 switches the CPV 130 to the open state, and the negative pressure formed in the fuel tank 110 reaches the preset reference negative pressure and is maintained at the reference negative pressure or less. When the pressure switch 146 is opened, the pressure switch 146 included in the NVLD module 140 may generate detection information indicating that the open state of the pressure switch 146 included in the NVLD module 140 is stuck. The reason may be described as follows. When the pressure of the fuel tank 110 falls below the reference negative pressure after the operation of the vehicle is started, the pressure switch 146 must be closed. However, since the pressure switch 146 maintains the open state, the detection control unit 240 may generate switch state error information indicating “stuck state”.

On the other hand, when the detection control unit 240 determines that the pressure switch 146 is closed, the purge control unit 230 may switch the CPV 130 to the close state. Then, when the closure time of the CPV 130 reaches a preset critical time, the detection control unit 240 may recheck the switch state information. The critical time may be determined on the basis of a fuel level and ambient temperature, and frequently varied according to a change of the fuel level and the ambient temperature.

When checking that the switch state information indicates the open state, the detection control unit 240 may determine that the fuel evaporative gas is leaking, and generate detection information on the leakage. When checking that the switch state information indicates the close state, the detection control unit 240 may determine that fuel evaporative gas is not leaking, and generate detection information on no leakage.

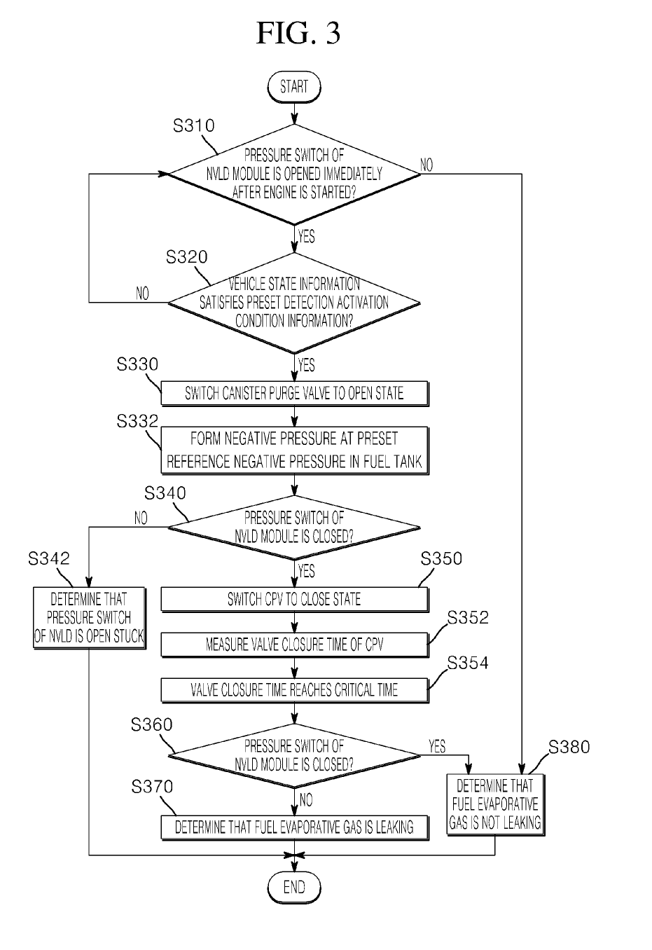

FIG. 3 is a flowchart for describing a method for detecting a leakage of fuel evaporative gas in accordance with an embodiment of the present invention.

The electronic control unit 150 may check the state of the pressure switch 146 included in the NVLD module 140 immediately after the engine 160 is started, at step S310. When the pressure switch 146 is closed, the electronic control unit 150 may determine that the vehicle fuel system is sealed and the internal pressure of the fuel tank 110 is maintained at the preset critical pressure or less, and not perform leakage detection.

When the pressure switch 146 is opened, the electronic control unit 150 may check whether the vehicle state information of the vehicle in operation satisfies all the pieces of detection activation condition information, and determine whether to activate leakage detection, at step S320.

When it is checked at step S320 that the vehicle state information satisfies all the pieces of detection activation condition information, the electronic control unit 150 may activate leakage detection, and switch the CPV 130 to the open state, at step S330.

When a purge integrated value, a purge flow rate, and a satisfaction time condition of the CPV 130 are satisfied in a state where the CPV 130 is opened, the negative pressure formed in the fuel tank 110 may reach the preset reference negative pressure at step S332. In this case, the electronic control unit 150 may check whether the pressure switch 146 included in the NVLD module 140 is closed, at step S340.

When it is checked at step S340 that the pressure switch 146 included in the NVLD module 140 is opened, the electronic control unit 150 may determine that the open state of the pressure switch 146 included in the NVLD module 140 is stuck, and generate detection information on the open stuck state of the pressure switch, at step S342.

On the other hand, when it is checked at step S340 that the pressure switch 146 included in the NVLD module 140 is closed, the electronic control unit 150 may switch the CPV 130 to the close state at step S350.

The electronic control unit 150 may measure a valve closure time during which the CPV 130 is closed, at step S352. When the valve closure time reaches a preset critical time at step S354, the electronic control unit 150 may check the state of the pressure switch 146 included in the NVLD module 140 at step S360.

When it is checked at step S360 that the pressure switch 146 included in the NVLD module 140 is opened, the electronic control unit 150 may determine that fuel evaporative gas is leaking from the vehicle fuel system, and generate detection information on the leakage, at step S370.

When it is checked at step S360 that the pressure switch 146 included in the NVLD module 140 is closed, it may indicate that the internal pressure of the fuel tank 110 is normal. Thus, the electronic control unit 150 may determine that fuel evaporative gas is not leaking from the vehicle fuel system, and generate detection information on no leakage, at step S380.

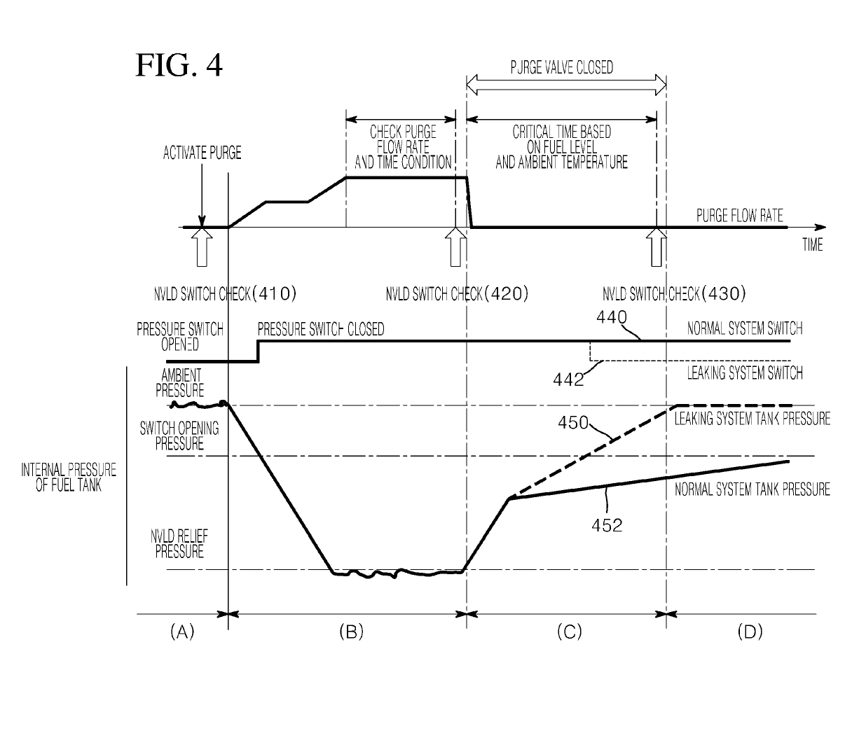

FIG. 4 is a graph for describing the operation of detecting a leakage of fuel evaporative gas in the electronic control unit in accordance with the embodiment of the present invention.

In a section A of FIG. 4, the electronic control unit 150 may check the state of the pressure switch 146 included in the NVLD module 140 immediately after the engine 160 is started, as indicated by reference numeral 410. When the pressure switch 146 is opened, the electronic control unit 150 may activate leakage detection for fuel evaporative gas, based on vehicle state information during operation and the preset detection activation condition information. When the leakage detection is activated, the electronic control unit 150 may switch the CPV 130 to the open state. The section A of FIG. 4 may correspond to the initial section in which the operation of the vehicle is normally started. During the section A, the pressure of the fuel tank 110 may be similar to the ambient pressure.

As illustrated in a section B of FIG. 4, when the operation of the vehicle is continued in a state where the CPV 130 is opened, negative pressure may be formed in the fuel tank 110 due to the negative pressure formed in the combustion chamber of the engine 160, and the internal pressure of the fuel tank 110 may gradually fall with the operation of the vehicle. When the negative pressure reaches the preset reference negative pressure in the fuel tank 110, the pressure switch 146 included in the NVLD module 140 may be switched to the close state.

Even after the pressure switch 146 is switched to the close state, the negative pressure of the fuel tank 110 may gradually fall. Then, when the negative pressure reaches the NVLD relief pressure which corresponds to the minimum pressure and is maintained by the vacuum relief 142, the negative pressure may be maintained at the NVLD relief pressure.

As illustrated in a section C of FIG. 4, the electronic control unit 150 may check the state of the pressure switch 146. When checking that the pressure switch 146 is opened, the electronic control unit 150 may generate detection information indicating that the open state of the pressure switch 146 included in the NVLD module 140 is stuck.

However, when checking that the pressure switch 146 is closed, the electronic control unit 150 may switch the CPV 130 to the close state.

Then, the electronic control unit 150 may measure a valve closure time during which the CPV 130 is closed, and check the state of the pressure switch 146 included in the NVLD module 140 when the valve closure time reaches a preset critical value.

When checking that the state of the pressure switch 146 corresponds to a normal system switch 440, that is, the close state, the electronic control unit 150 may determine that fuel evaporative gas is not leaking. In the section C of FIG. 4, the electronic control unit 150 may check that the negative pressure of the fuel tank 110 is changed to pressure corresponding to the ambient pressure at normal speed as indicated by reference numeral 452.

When it is checked that the state of the pressure switch 146 corresponds to a leaking system switch 442, the electronic control unit 150 may determine that fuel evaporative gas is leaking. In the section C of FIG. 4, the electronic control unit 150 may check that the negative pressure of the fuel tank 110 is changed toward the pressure corresponding to the ambient pressure at abnormal speed as indicated by reference numeral 450.

In accordance with the embodiment of the present invention, the apparatus for detecting a leakage of fuel evaporative gas may detect a leakage of fuel evaporative gas using the NVLD module. Thus, since a pressure sensor and a canister block valve do not need to be installed in the fuel tank, the cost of the fuel system can be reduced.

When the preset detection activation condition information is satisfied, the leakage detection apparatus may activate leakage detection to detect a leakage of fuel evaporative gas during operation of the vehicle. Thus, the leakage detection apparatus can detect a leakage without a separate idle section for leakage detection in a vehicle to which a hybrid and ISG (Idle Stop and Go) system is applied, which makes it possible to improve fuel efficiency and reduce the cost.

The leakage detection apparatus may detect a leakage of fuel evaporative gas after checking the constant vehicle speed operation condition and the fuel level condition during operation of the vehicle. Thus, the leakage detection apparatus can distinguish the size of a leakage under a stable condition during detection, and improve the reliability of leakage detection.

The leakage detection apparatus does not need to separately open the CPV for leakage detection and to set a target value for purge flow rate. Furthermore, the leakage detection apparatus may stop the operation of the purge valve only during a section in which the pressure switch is reopened after negative pressure is formed in the fuel tank, thereby minimizing the influence on the operation of the vehicle due to the separate operation of the purge valve.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. An apparatus for detecting a leakage of fuel evaporative gas, comprising:
a natural vacuum leakage detection (NVLD) module including a pressure switch; and
an electronic control unit configured to determine whether the pressure switch is opened or closed, when internal pressure of a fuel tank is maintained at a preset reference negative pressure or less during operation of a vehicle, and generate leakage detection information based on switch state information of the pressure switch.

2. The apparatus of claim 1, wherein the pressure switch is switched to an open state when the internal pressure is equal to or more than the preset reference negative pressure, and switched to a close state when the internal pressure is less than the reference negative pressure.

3. The apparatus of claim 1, wherein the electronic control unit measures the time during which the internal pressure is maintained at the preset reference negative pressure or less, and checks the switch state information of the pressure switch after the time elapses by a preset critical time.

4. The apparatus of claim 1, wherein the electronic control unit generates the leakage detection information by checking the switch state information of the pressure switch immediately after an engine of the vehicle is started.

5. The apparatus of claim 4, wherein when the pressure switch is opened and all pieces of preset detection activation condition information are satisfied, the electronic control unit activates leakage detection to generate the leakage detection information.

6. The apparatus of claim 5, wherein the detection activation condition information indicates information on reference conditions which are set in order to activate the leakage detection for fuel evaporative gas during operation, and comprises one or more of a related part state condition, an ambient temperature condition, an engine stop time condition, an engine operation time condition, a fuel level condition, a constant vehicle speed operation condition, and a purge flow rate condition.

7. The apparatus of claim 4, wherein when the pressure switch is closed, the electronic control unit determines that the internal pressure of the fuel tank is maintained at the preset reference negative pressure or less, and deactivates the leakage detection.

8. The apparatus of claim 7, wherein after a canister purge valve (CPV) is switched to the open state during operation of the vehicle such that the internal pressure is maintained at the preset reference negative pressure or less, the electronic control unit rechecks the state of the pressure switch, and generates detection information on the open stuck state of the pressure switch in case where the pressure switch is opened.

9. The apparatus of claim 8, wherein when the internal pressure is maintained at the preset reference negative pressure or less in a state where the CPV is opened, the electronic control unit switches the CPV to the close state, and rechecks the state of the pressure switch in case where a switch closure time of the CPV reaches a preset critical time.

10. The apparatus of claim 9, wherein when the switch closure time elapses by the critical time which is determined on the basis of one or more of a fuel level and ambient temperature, the electronic control unit checks the state of the pressure switch.

11. The apparatus of claim 9, wherein the electronic control unit rechecks the state of the pressure switch and determines that the fuel evaporative gas is not leaking, when the pressure switch is closed, or determines that the fuel evaporative gas is leaking, when the pressure switch is opened.

12. The apparatus of claim 1, wherein the electronic control unit comprises:
a switch check unit configured to check switch state information on the open state or close state of the pressure switch;
a condition determination unit configured to determine whether to activate leakage detection for fuel evaporative gas, based on preset detection activation condition information;
a purge control unit configured to control a valve switching operation of a CPV; and
a detection control unit configured to control the internal pressure of the fuel tank to be maintained at the preset reference negative pressure or less according to control of the CPV, when the leakage detection is activated according to the switch state information, check the switch state information which is changed according to a variation of the internal pressure, and generate detection information by determining whether the fuel evaporative gas is leaking.

13. The apparatus of claim 12, wherein the purge control unit switches the CPV to the open state, and switches the CPV to the close state when the internal pressure reaches the preset reference negative pressure, and
the detection control unit checks the switch state information when the switch closure time of the CPV reaches a preset critical time.

14. The apparatus of claim 13, wherein when the switch state information indicates the close state, the detection control unit determines that the internal pressure is maintained at the preset reference negative pressure or less during the switch closure time, and generates the detection information indicating that the fuel evaporative gas is not leaking.

15. The apparatus of claim 13, wherein when the switch state information indicates the open state, the detection control unit determines that the internal pressure rose over the preset reference negative pressure during the switch closure time, and generates the detection information indicating that the fuel evaporative gas is leaking.

16. The apparatus of claim 12, wherein the purge control unit switches the CPV to the open state when the leakage detection is activated, and switches the CPV to the close state when the internal pressure reaches the preset reference negative pressure such that the pressure switch is switched from the open state to the close state.

17. A method for detecting a leakage of fuel evaporative gas, comprising:
a switch operation step of opening or closing a pressure switch based on internal pressure of a fuel tank;
a determination step of determining whether the pressure switch is opened or closed, when the internal pressure of the fuel tank is maintained at a preset reference negative pressure or less during operation of a vehicle; and
a detection step of generating leakage detection information based on the switch state information of the pressure switch.

18. The method of claim 17, wherein the switch operation step comprises switching the pressure switch to the open state when the internal pressure is equal to or more than the preset reference negative pressure, and switching the pressure switch to the close state when the internal pressure is less than the reference negative pressure.

19. The method of claim 17, wherein the determination step comprises rechecking the state of the pressure switch after a CPV is switched to the open state during operation of the vehicle such that the internal pressure is maintained at the preset reference negative pressure or less, and generating detection information on the open stuck state of the pressure switch when the pressure switch is opened.

20. The method of claim 18, wherein the detection step comprises switching the CPV to the close state when the internal pressure is maintained at the preset reference negative pressure or less in a state where the CPV is opened, and rechecking the state of the pressure switch when a switch closure time of the CPV reaches a preset critical time.

21. The method of claim 20, wherein the detection step comprises rechecking the state of the pressure switch and determining that the fuel evaporative gas is not leaking, when the pressure switch is closed, or determining that the fuel evaporative gas is leaking, when the pressure switch is opened.
